(19) United States
(12) Patent Application Publication
(10) Pub. No.: US 2016/0344902 A1
(43) Pub. Date: Nov. 24, 2016

(54) STREAMING REPRODUCTION DEVICE, AUDIO REPRODUCTION DEVICE, AND AUDIO REPRODUCTION METHOD

(71) Applicant: GWANGJU INSTITUTE OF SCIENCE AND TECHNOLOGY, Gwangju (KR)

(72) Inventors: Hong-Kook KIM, Gwangju (KR); Seok-Hee JEONG, Gwangju (KR); Chan-Jun CHUN, Gwangju (KR)

(21) Appl. No.: 15/159,752

(22) Filed: May 19, 2016

(30) Foreign Application Priority Data
May 20, 2015 (KR) 10-2015-00070280

(51) Int. Cl. H04N 5/04; H04N 5/60

(52) U.S. Cl. CPC H04N 5/04; H04N 5/607

(57) ABSTRACT

A streaming reproduction device according to the present disclosure includes a decoder for decoding a file transmitted from a library, an image reproduction device for reproducing an image decoded in the decoder, an audio reproduction device for reproducing an audio decoded in the decoder, and a synchronizer for synchronizing image information with audio information to output the synchronized information. In accordance with the present disclosure, regardless of file information and a communication environment, the stereo extension device may be optimally activated, a sound quality may be improved, and stereo may be stably provided under a streaming environment.

### CROSS REFERENCE TO RELATED APPLICATION

This application claims the benefit of Korean Patent Application No. 10-2015-0070280, filed on May 20, 2015, entitled “STREAMING REPRODUCTION DEVICE, AUDIO REPRODUCTION DEVICE, AND AUDIO REPRODUCTION METHOD”, which is hereby incorporated by reference in its entirety into this application.

### BACKGROUND

1. Technical Field

The present disclosure relates to a streaming reproduction device, an audio reproduction device, and an audio reproduction method.

2. Description of the Related Art

Stereo has two channels configuring a sound, and means an audio reproduction method reproducing audio channels different from each other through a configuration of two speakers. As described above, different sounds are reproduced from the two speakers so that spatial impression and directional impression may be provided. On the other hand, mono means a method in which two speakers reproduce the same sound, and has a single channel.

Generally, listeners prefer stereo. However, when recording information is mono, only a mono sound is reproduced even if a stereo instrument is provided. In this case, there is a way in which an artificial stereo sound can be reproduced by extending a mono signal to a stereo signal. As a representative example, there is Korean Patent Registration No. 10-1461110, entitled “Stereo Extension Device and Stereo Extension Method” by the same Applicant. Contrary to public expectations, when mono is extended to stereo to be operated under a circumstance in which there is no need to a stereo extension device, it may induce a degradation of sound quality and an unnecessary calculation amount to cause a loss of a system.

Under actual circumstances, same information is stored in each of two channels in spite of existence of the two channels so that a sound is frequently reproduced in mono. Also, information is actually stored in stereo although a file format is mono, so that a sound is frequently reproduced in mono because an internal process of a reproduction instrument processes the information as mono. In addition, only mono information is transmitted although original information is stereo according to communication conditions, so that stereo and mono are frequently reproduced by being interchanged with each other upon reproduction of one audio file. Specifically, in a streaming service which provides a real time reproduction using a communication, such problems described above may occur much more to cause inconvenience.

### SUMMARY

The present disclosure has been conceived to solve such problems and it is an aspect of the present disclosure to provide a streaming reproduction device, an audio reproduction device, and an audio reproduction method, which are capable of improving user's satisfaction upon reproducing an audio. Also, it is another aspect of the present disclosure to provide a streaming reproduction device, an audio reproduction device, and an audio reproduction method, which are capable of providing an optimal stereo regardless of a file format, information regarding a number of channels, and a communication environment.

Moreover, it is still another aspect of the present disclosure to provide a streaming reproduction device, an audio reproduction device, and an audio reproduction method, which are capable of minimizing a calculation amount of a stereo extension device and obtaining a best stereo sound quality under a streaming circumstance.

A streaming reproduction device according to the present disclosure includes a decoder configured to decode a file transmitted from a library, an image reproduction device configured to reproduce an image decoded in the decoder, an audio reproduction device configured to reproduce an audio decoded in the decoder, and a synchronizer configured to synchronize image information with audio information to output the synchronized information, wherein the audio reproduction device includes a channel number determination unit configured to determine a number of audio channels included in the file, a mono/stereo determination unit configured to determine whether or not information of two channels is an actual stereo signal when the channel number determination unit determines the number of audio channels as the two channels, and a stereo extension device configured to extend to a stereo signal when the number of audio channels is determined as a single channel, or the mono/stereo determination unit determines as a mono signal.

In the streaming reproduction device, the mono/stereo determination unit may determine whether or not the information is the actual stereo signal using an inter-channel coherence, and the library may be connectable through Internet.

Also, the audio reproduction device may include a smoothing unit configured to weighting a weight value to each of an original channel value and an extended channel value by the stereo extension device to perform a smoothing operation on the channel values. Here, the weight value may have a value in a range of 0 to 1, and a sum of the weight values may be 1.

An audio reproduction device according to the present disclosure includes a channel number determination unit configured to determine a number of channels included in audio information, a mono/stereo determination unit configured to determine whether or not information of two channels is an actual stereo signal when the channel number determination unit determines the number of audio channels as the two channels, and a stereo extension device configured to extend to a stereo signal using an original channel value to calculate and output an extended channel value at least one of cases in which the number of channels is determined as a single channel and in which the mono/stereo determination unit determines as a mono signal.

In the audio reproduction device, a smoothing unit configured to smooth the original channel value and the extended channel value to obtain a final output signal may be further included. Here, the smoothing operation of the smoothing unit may be performed by multiplying weight values by the original channel value and the extended channel value and adding the channel values to each other, each of the weight values may have a value in a range of 0 to 1, and a sum of the weight values may be 1. Also, the weight value regarding the original channel value may be increased by a step of a predetermined value when the determination result of the mono/stereo determination unit is a mono signal, and the weight value regarding the extended channel value may be increased by a step of a predetermined value when the determination result of the mono/stereo determination unit is a stereo signal, in the weight values regarding the original channel value and the extended channel value. In addition, the stereo extension device may not be activated when the weight value regarding the extended channel value is zero.

An audio reproduction method according to the present disclosure includes determining whether or not a channel of an input signal is two channels, extending to and outputting a stereo signal when the channel is a single channel as a mono signal, determining whether or not the input signal is an actual stereo signal using an inter-channel coherence of two channels when the channel is the two channels as a stereo signal, determining as the mono signal to perform a stereo extension when the inter-channel coherence is high as the determination result of the actual stereo signal, and smoothing and outputting an original stereo signal and the extended stereo signal.

In the audio reproduction method, a weight value of the smoothing operation may be gradually varied by determining whether or not the input signal is an actual stereo signal at every frame, and the extending to the stereo signal may not be performed when a weight value of the extended stereo signal is zero. Therefore, an unnecessary calculation amount may be reduced.

In accordance with the present disclosure, regardless of file information and a communication environment, the stereo extension device may be optimally activated, a sound quality may be improved, and stereo may be stably provided under a streaming environment.

The present disclosure may be applicable to a computer, a mobile terminal, or a device on which an operational device and an audio reproduction device are mounted, thereby implementing an optimal stereo regardless of a state and a present condition of audio information. In particular, under a streaming circumstance requiring a high-speed processing, there may be effectiveness capable of providing a stereo sound without a heavy load with respect to a system.

### BRIEF DESCRIPTION OF DRAWINGS

FIG. 1 is a block diagram of a streaming reproduction device according to an embodiment.

FIG. 2 is a block diagram of an audio reproduction device according to an embodiment.

FIG. 3 is a diagram for describing a stereo extension device.

FIG. 4 is a diagram for describing an audio reproduction method.

### DETAILED DESCRIPTION

Hereinafter, a concrete embodiment of the present disclosure will be described in detail with reference to the accompanying drawings. However, the spirit of the present invention is not limited to the embodiments disclosed herein, and a person skilled in the art who understands the spirit of the present invention would be able to easily offer other embodiments within the scope of other retrograde invention or the present invention by adding, changing, deleting, and appending other components within the same spirit, and it is also intended to be included in the spirit of the present invention.

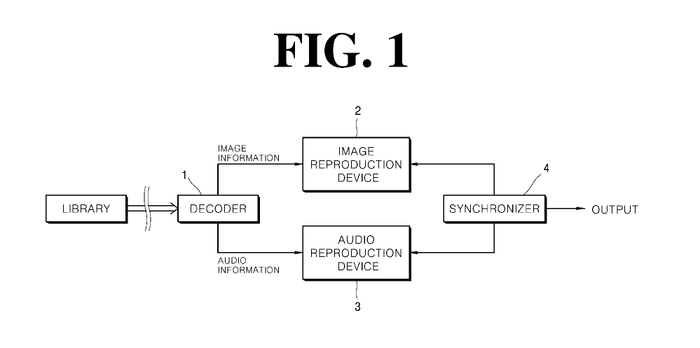

FIG. 1 is a block diagram of a streaming reproduction device according to an embodiment.

With reference to FIG. 1, a decoder 1 receives and decodes a file from a library in which a moving image including audio information is stored. Decoded information in the decoder 1 is separated into image information and audio information, and then the image information is processed in an image reproduction device 2 and the audio information is processed in an audio preproduction device 3. The image and audio information processed in the reproduction devices 2 and 3 are synchronized in a synchronizer 4 and then the synchronized image and audio is output to a user.

The library may be YouTube as a representative, but it is not limited thereto, and a variety of servers accessible to Internet may be included. The streaming reproduction device may receive a streaming service by connecting to the library through wire/wireless communications.

The image reproduction device 2 processes the image information to provide the synchronizer 4 with the processed image information, and the audio reproduction device 3 processes the audio information to provide the synchronizer 4 with the processed audio information. The audio reproduction device 3 determines a number of channels. Depending on the determined number of channels, stereo is provided using a stereo extension device when the determined number of channels is one, that is, mono of a single channel, whereas a determination whether it is actually mono or stereo using an inter-channel coherence (ICC) is again performed when the determined number of channels is two, that is, stereo of two channels.

The audio reproduction device 3 may accurately perform a determination of mono or stereo because of determining the mono or stereo based on the number of channels regardless of information obtainable from a file format indicating stereo or mono. At this point, when the number of channels is one, it is clearly determined as mono so that a stereo signal may be generated using a mono signal through a stereo extension device to increase a feeling of satisfaction of a user. Even though the number of channels is two, a real sound may fall short of stereo so that a feeling of stereo may be again enhanced through the stereo extension device when a high ICC is obtained through an analysis of an ICC. In this case, the feeling of satisfaction of the user may be increased much more. When an ICC is low, the stereo extension device is not activated so that a system resource may be saved and an original quality of stereo sound may be provided.

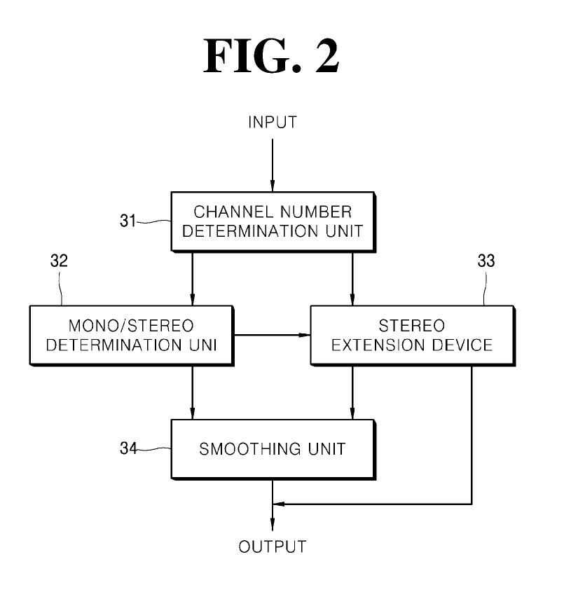

FIG. 2 is a block diagram of an audio reproduction device according to an embodiment.

With reference to FIG. 2, a channel number determination unit 31 determining a number of channels is included. When the channel number determination unit 31 determines as mono in which a number of channels is one, a stereo extension device 33 extends a mono signal to a stereo signal. When the channel number determination unit 31 determines as stereo in which a number of channels is two, a mono/stereo determination unit 32 determines mono or stereo depending on an ICC. Using the ICC, the mono/stereo determination unit 32 determines as mono when the ICC is equal to or greater than a predetermined level to extend a signal to a stereo signal through a stereo extension device 33, whereas it determines as stereo when the ICC is less than the predetermined level not to use the stereo extension device 33 except for a case in which a smoothing to be described later requires the stereo extension device 33. The stereo extension device will be described later.

The ICC may be expressed by Equation 1.

$$ICC = \frac{\text{?} {x}_{L} ( n ) {x}_{R} ( n )}{\sqrt{\text{?} {x}_{L}^{2} ( n ) \cdot \text{?} {x}_{R}^{2} ( n )}} \\ \text{?} \text{indicates text missing or illegible when filed} \qquad [ Equation 1 ]$$

In Equation 1, x_{L}(n) represents a sound source of a left channel at a predetermined time n, and x_{R}(n) represents a sound source of a right channel at the predetermined time n. When the ICC comes close to 1, it may be determined as mono, and otherwise, when the ICC comes close to 0, it may be determined as stereo. Although 0.98 is used as a threshold value by the inventor, but it is not limited thereto, and it may be understood that a mono determination is tolerant as the threshold value is lower and a stereo determination is tolerant as the threshold value is higher.

When an original signal is determined as a mono signal in the mono/stereo determination unit 32, the stereo extension device 33 firstly extends the original signal to a stereo signal using a signal of one of two channels. And, a smoothing unit 34 smooths the extended stereo signal and the original signal. With such an operation, an abrupt variation of sound quality caused by the smoothing in the smoothing unit 34, that is, a phenomenon changing from stereo to mono or from mono to stereo may be prevented. In other words, information provided to the two channels and the extended stereo signal are separately smoothed in left and right sides.

An operation of the smoothing unit 34 will be described in more detail.

y_{L}(n)=w₁\hat{x}_{L}(n)+w₂x_{L}(n) [Equation 2]

In Equation 2, a subscript L means a left channel of stereo, and n means a predetermined time. Therefore, y_{L}(n) is a left channel value of stereo and a final output signal smoothed by the smoothing unit 34, \hat{x}_{L} is an extended left channel value by the stereo extension device 33, w₁ is a weight value of the extended left channel value by the stereo extension device 33, x_{L} is an original left channel value before the stereo extension, and w₂ is a weight value of the original left channel value before the stereo extension.

Illustratively, a sum of the weight values w₁ and w₂ becomes 1, and each of the weight values is varied by a step of 0.1. Also, in a pair of consecutive frames in a time domain, when a state is changed from mono to stereo and vice versa, each of the weight value is increased or decreased by a step of 0.1. For example, when a previous frame is determined as mono, w₁ is 0.2, and w₂ is 0.8, the weight values of w₁ and w₂ are adjusted to 0.1 and 0.9, respectively, when a current frame is determined as stereo. Under the same circumstance, when the current frame is determined as mono, the weight values of w₁ and w₂ are adjusted to 0.3 and 0.7, respectively.

The smoothing operation may be understood as a weight value adjustment in which a weight value regarding the original signal x_{L} is increased by one step, and a weight value regarding the extended signal \hat{x}_{L} is decreased by one step when the current frame is determined as stereo. With such a smoothing operation, an abrupt variation of the final signal according to a determination of mono or stereo per frame may be prevented so that the user may feel comfortable.

In addition, a right channel value of stereo to be smoothed may be obtained by performing a smoothing operation the same as the method expressed in Equation 2 using a weight value of an extended right channel value obtained from the stereo extension device 33 and a weight value of an original right channel value before the stereo extension.

Meanwhile, the spirit of the present disclosure includes a case in which an extended stereo signal and an original stereo signal may be output without employing the smoothing unit. However, when the smoothing unit is provided, it may obtain an advantage that the feeling of satisfaction of the user may be increased.

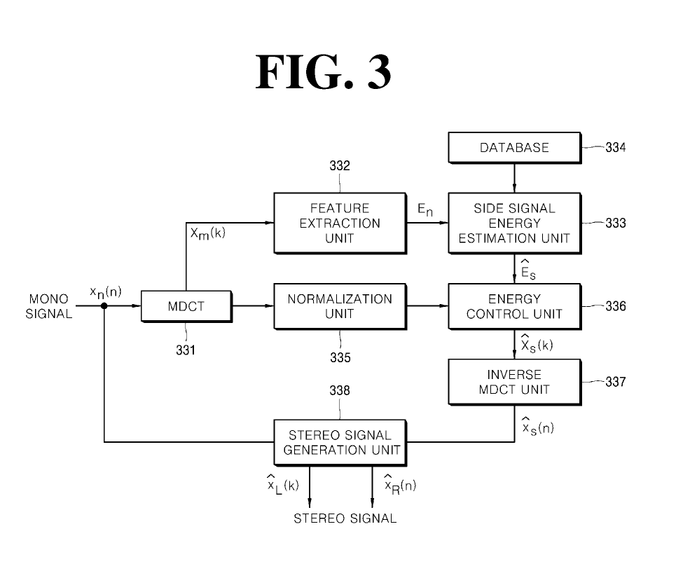

FIG. 3 is a diagram for describing a stereo extension device. A stereo extension device to be described may be merely one embodiment, and other type stereo extension device may also be used.

Also, the stereo extension device may be controlled to perform the smoothing operation expressed by Equation 2 only when a weight value regarding the extended signal \hat{x}_{L} is not zero. Consequently, a generation of an unnecessary calculation amount may be reduced.

With reference to FIG. 3, there is shown a case receiving a mono signal from one of two channels, and a modified discrete cosine transform (MDCT) unit 331 for transforming a mono signal being input into an MDCT domain as a mid signal, a feature extraction unit 332 for extracting a sub-band energy vector of the mid signal as a feature value, a database 334 for storing information provided as a result of a Gaussian mixture model (GMM) training or a hidden Markov (HMM) model training by utilizing known audio data, and a side signal energy estimation unit 333 for estimating a subband energy of a side signal with reference to information stored in the database 334 on the basis of the subband energy vector of the mid signal provided from the feature extraction unit 332 are included in the stereo extension device 33.

Also, a normalization unit 335 for normalizing an MDCT coefficient being extracted from the MDCT unit 331, and an energy control unit 336 for obtaining an estimated MDCT coefficient of the side signal using the normalized MDCT coefficient output from the normalization unit 335 and a subband energy of an estimated side signal output from the side signal energy estimation unit 333 are included.

In addition, an inverse MDCT unit 337 for obtaining an estimated side signal by performing an inverse MDCT on the MDCT coefficient of the estimated side signal, and a stereo signal generation unit 338 for obtaining left and right stereo signals through a sum of the mono signal and the side signal and a difference therebetween are included.

Hereinafter, the database 334 will be described in detail.

The GMM training or the HMM training will be described as a process for generating information stored in the database 334.

As training data for performing the GMM training or the HMM training, 50 standard audio data may be prepared. The standard audio data may be obtained from a sound quality assessment material (SQAM). At this point, the standard audio data is stored at a sampling rate of 44.1 kHz so that a process of a down sampling from 44.1 kHz to 32 kHz may be further performed.

A left signal x_{L}(n) and a right signal x_{R}(n) are stored in the training data as a stereo signal. And, Equation 3 may be established between a mid signal xₘ(n) and a side signal xₛ(n), and between the left signal x_{L}(n) and the right signal x_{R}(n).

xₘ(n)−(x_{L}(n)+x_{R}(n))/2,

xₛ(n)−(x_{L}(n)−x_{R}(n))/2 [Equation 3]

The mid signal xₘ(n) and the side signal xₛ(n) may be transformed into an MDCT domain. Further, subband energy may be expressed by Equation 4.

$${E}_{m} ( b ) = \sqrt{\text{?} {X}_{m}^{2} ( k )} \\ and {E}_{s} ( b ) = \sqrt{\text{?} {X}_{s}^{2} ( h )} \\ \text{?} \text{indicates text missing or illegible when filed} \qquad [ Equation 4 ]$$

In Equation 4, b may have a value in a range of 0 to 14, and Xₘ(k) and Xₛ(k) are MDCT coefficients in a k-th frequency band of the mid signal xₘ(n) and the side signal xₛ(n). Therefore, Eₘ(b) may be given as subband energy of the mid signal and Eₛ(b) may be given as subband energy of the side signal. A number of subbands is given as 15 in an embodiment, and it may be changed.

Subband energy of each frame may be given as a feature parameter in the GMM training or the HMM training. Eₘ=[Eₘ(0), . . . Eₘ(14)] may be given as a spectrum subband energy vector of the mid signal, and Eₘ=[Eₛ(0), Eₛ(1), . . . Eₛ(14)] may be given as a spectrum subband energy vector of the side signal. Further, the two subband energy vectors may be connected to each other to be expressed as E=[Eₘ, Eₘ].

As a parameter with respect to the GMM training or the HMM training, the subband energy vectors of the mid signal and the side signal may be trained by an expectation maximization algorithm (EM algorithm).

Information provided through the described above process may be stored in the database 334.

Hereinafter, a configuration and an operation of the stereo extension device will be described in more detail.

Referring back to FIG. 3, the MDCT unit 331 for transforming a mono signal being input into an MDCT domain is provided. The MDCT unit 331 may transform a mono signal xₘ(n) having a frame size of 640 into a frequency domain using the MDCT having 1280 points. The MDCT coefficient Xₘ(k) of the mono signal may be grouped into 15 subbands. Here, each subband may include 80 MDCT coefficients.

As similarly in Equation 4, b-th subband energy Eₘ(b) may be extracted from the MDCT coefficient Xₘ(k) of the mono signal. The normalization unit 335 normalizing the MDCT coefficient Xₘ(k) of the mono signal using the b-th subband energy Eₘ(b) is provided. The normalization unit 335 may perform normalization through a method of Equation 5. As another embodiment, a normalization according to other method may not be excluded.

$$\overline{X} \text{?} ( k ) = \{ \begin{matrix}\frac{X \text{?} ( k )}{{E}_{s} ( b )} , & 0 \leq k < 40 \\ \begin{matrix}\frac{{X}_{m} ( k ) \text{?} ( k - 40 ) ( b - \text{?} )}{{E}_{s} ( b - 1 )} + \\ \frac{X \text{?} ( k ) \text{?} ( k - 400 )}{{E}_{s} ( b )}\end{matrix} , & 40 \leq k < 600 \\ \frac{X \text{?} ( k )}{{E}_{s} ( b - 1 )} , & 600 \leq k < 640\end{matrix} \\ \text{?} \text{indicates text missing or illegible when filed} \qquad [ Equation 5 ]$$

Here, b=*k/40+, X̅ₘ(k) is the normalized MDCT coefficient of the mono signal, and w(l) is a cosine window having a length of 80.

The normalized MDCT coefficient X̅ₘ(k) of the mono signal may be an estimated value of the side signal.

The b-th subband energy Êₛ(b) of the estimated side signal may be estimated by the subband energy vector Eₘ of the mid signal. Here, the subband energy vector may be extracted by the feature extraction unit 332.

The side signal energy estimation unit 333 may obtain the b-th subband energy Êₛ(b) of the estimated side signal by a minimum mean squared error (MMSE) method based on the GMM training or the HMM training.

The energy control unit 336 may obtain the estimated MDCT coefficient \hat{X}ₛ(k) of the side signal using the normalized MDCT coefficient X̅ₘ(k) of the mono signal and the subband energy Êₛ(b) of the estimated side signal. In particular, it may be given as Equation 6 as follows.

$${\hat{X}}_{s} ( k ) = \{ \begin{matrix}{\overline{X}}_{m} ( k ) {\hat{E}}_{s} ( b ) , & 0 \leq k < 40 \\ \begin{matrix}{\overline{X}}_{m} ( k ) {\hat{E}}_{s} ( b - 1 ) \text{?} ( k - 40 ( b - 1 ) ) + \\ {\overline{X}}_{m} ( k ) {\hat{E}}_{s} ( b ) \text{?} ( k - 40 \text{?} )\end{matrix} , & 40 \leq k < 600 \\ {\overline{X}}_{m} ( k ) {\hat{E}}_{s} ( b - 1 ) , & 600 \leq k < 640\end{matrix} \\ \text{?} \text{indicates text missing or illegible when filed} \qquad [ Equation 6 ]$$

Next, the inverse MDCT unit 337 may obtain the estimated side signal \hat{X}ₛ(n) by performing the inverse MDCT having 1280 points on the estimated MDCT coefficient \hat{X}ₛ(k) of the side signal.

Lastly, the stereo signal generation unit 338 may obtain a stereo signal through a sum of the mono signal and the side signal and a difference therebetween. In particular, an estimated stereo signal may be generated using Equation 7. It can be easily understood that the mono signal is regarded as the mid signal.

\hat{x}_{L}(n)=xₘ(n)+\hat{x}ₛ(n),

\hat{x}_{R}(n)=xₘ(n)−\hat{x}ₛ(n). [Equation 7]

Here, \hat{x}_{L}(n) is a left signal of the estimated stereo signal and \hat{x}_{R}(n) is a right signal thereof.

As described above, the mono signal being input may be regarded as the mid signal to provide a stereo signal extended based on the mono signal.

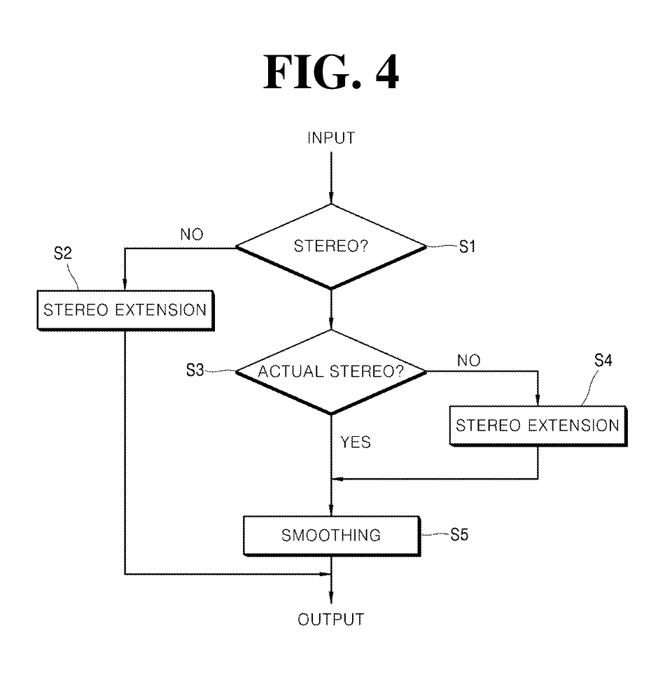

FIG. 4 is a diagram for describing an audio reproduction method. In describing the audio reproduction method according to an embodiment, insufficient portions may be referred the audio reproduction device described with reference to FIG. 2.

With reference to FIG. 4, it is determined whether or not an input signal has two channels as a stereo signal in Operation S1. If it is determined that the input signal is not a stereo signal, the input signal is extended to a stereo signal to be output in Operation S2. On the other hand, if it is determined that the input signal is a stereo signal, it is determined whether the input signal is an actual stereo signal using an ICC of two channels in Operation S3. If the ICC is high (for example, over 0.98) as the determination result of Operation S3, the input signal is determined as a mono signal even though the input signal is the stereo signal having two channels, to thereby be subject to a stereo extension in Operation S4. Otherwise, if the input signal is determined as a stereo signal because the ICC is low, the stereo extension is not performed except for a case in which a smoothing operation is required as the following description. Consequently, a calculation amount may be reduced to obtain an advantage for preventing a waste of a hardware resource.

If it is determined whether or not the input signal is the actual stereo signal and the extended stereo signal is provided, the smoothing operation described as Equation 2 is performed in Operation S2. The smoothing operation may be performed by applying weight values to the extended stereo signal and the original stereo signal, respectively, and mixing the signals with each other. Therefore, even if a current signal is determined as a stereo signal at the actual stereo determination in Operation S3, when the weight value regarding the extended stereo signal is not zero, the extended stereo signal may be obtained using the stereo extension device 33.

In order to evaluate the present embodiment, by manufacturing App according to the present embodiment, mounting App on Galaxy Tab S commercially available and produced by Samsung Electronics Co., Ltd., and testing App using a moving image of You Tube as a library, it can be seen that a maximum memory usage of App is 102 MB, a central processing unit (CPU) occupation thereof is 33%, and App can be operable in real time on a random access memory (RAM) of 3 GB.

What is claimed is:

1. A streaming reproduction device comprising:
a decoder configured to decode a file transmitted from a library;
an image reproduction device configured to reproduce an image decoded in the decoder;
an audio reproduction device configured to reproduce an audio decoded in the decoder; and
a synchronizer configured to synchronize image information with audio information to output the synchronized information,
wherein the audio reproduction device includes:
a channel number determination unit configured to determine a number of audio channels included in the file;
a mono/stereo determination unit configured to determine whether or not information of two channels is an actual stereo signal when the channel number determination unit determines the number of audio channels as the two channels; and
a stereo extension device configured to extend to a stereo signal when the number of audio channels is determined as a single channel, or the mono/stereo determination unit determines as a mono signal.

2. The streaming reproduction device of claim 1, wherein the mono/stereo determination unit determines whether or not the information is the actual stereo signal using an inter-channel coherence.

3. The streaming reproduction device of claim 1, wherein the library is connectable through Internet.

4. The streaming reproduction device of claim 1, wherein the audio reproduction device includes a smoothing unit configured to weight a weight value to each of an original channel value and an extended channel value by the stereo extension device to perform a smoothing operation on the channel values.

5. The streaming reproduction device of claim 4, wherein the weight value has a value in a range of 0 to 1, and a sum of the weight values is 1.

6. An audio reproduction device comprising:
a channel number determination unit configured to determine a number of channels included in audio information;
a mono/stereo determination unit configured to determine whether or not information of two channels is an actual stereo signal when the channel number determination unit determines the number of audio channels as the two channels; and
a stereo extension device configured to extend to a stereo signal using an original channel value to calculate and output an extended channel value at least one of cases in which the number of channels is determined as a single channel and in which the mono/stereo determination unit determines as a mono signal.

7. The audio reproduction device of claim 6, further comprising:
a smoothing unit configured to smooth the original channel value and the extended channel value to obtain a final output signal.

8. The audio reproduction device of claim 7, wherein the smoothing operation of the smoothing unit is performed by multiplying weight values by the original channel value and the extended channel value and adding the channel values to each other, each of the weight values has a value in a range of 0 to 1, and a sum of the weight values is 1.

9. The audio reproduction device of claim 7, wherein the weight value regarding the original channel value is increased by a step of a predetermined value when the determination result of the mono/stereo determination unit is a mono signal, and the weight value regarding the extended channel value is increased by a step of a predetermined value when the determination result of the mono/stereo determination unit is a stereo signal, in the weight values regarding the original channel value and the extended channel value.

10. The audio reproduction device of claim 9, wherein the stereo extension device is not activated when the weight value regarding the extended channel value is zero.

11. An audio reproduction method comprising:
determining whether or not a channel of an input signal is two channels;
extending to and outputting a stereo signal when the channel is a single channel as a mono signal;
determining whether or not the input signal is an actual stereo signal using an inter-channel coherence of two channels when the channel is the two channels as a stereo signal;
determining as the mono signal to perform a stereo extension when the inter-channel coherence is high as the determination result of the actual stereo signal; and
smoothing and outputting an original stereo signal and the extended stereo signal.

12. The audio reproduction method of claim 11, wherein a weight value of the smoothing operation is gradually varied by determining whether or not the input signal is an actual stereo signal at every frame.

13. The audio reproduction method of claim 12, wherein the extending to the stereo signal is not performed when a weight value of the extended stereo signal is zero.
